(19) United States
(12) Patent Application Publication
(10) Pub. No.: US 2014/0001241 A1
(43) Pub. Date: Jan. 2, 2014

(54) SOLDER BALL PRINTING AND MOUNTING APPARATUS

(71) Applicant: Hitachi, Ltd., Tokyo (JP)

(72) Inventors: Akio IGARASHI, Tsuchiura (JP); Ryosuke MIZUTORI, Tokyo (JP); Masaru MITSUMOTO, Ryugasaki (JP); Naoaki HASHIMOTO, Ryugasaki (JP)

(21) Appl. No.: 13/930,073

(22) Filed: Jun. 28, 2013

(30) Foreign Application Priority Data
Jun. 28, 2012 (JP) 2012-145266

(51) Int. Cl. B23K 3/08

(52) U.S. Cl. CPC B23K 3/08
USPC 228/9

(57) ABSTRACT

A substrate is mounted on a first conveying carrier including a flat surface, transferred onto a printing table of a flux printer, transferred from the flux printer onto a second conveying carrier, transferred from the second conveying carrier onto a printing table of a solder ball printer, and transferred from the solder ball printer onto a third conveying carrier using a first carry-in mechanism, a first carry-out mechanism, a second carry-in mechanism, and a second carry-out mechanism including a plurality of vacuum attraction pads. Images of alignment marks provided at four corners of the substrate on the printing tables and four corners of a mask are simultaneously picked up by separate camera units on a front side and a rear side in a conveying direction to calculate a positional deviation amount.

### BACKGROUND OF THE INVENTION

1. Field of the Invention

The present invention relates to a printer for printing a solder ball on an electrode of a semiconductor substrate and, more particularly, to a solder ball printing and mounting apparatus in which a flux printer that prints a flux and a solder ball printer that prints a solder ball are linked.

2. Description of the Related Art

A solder ball printing and mounting apparatus of the related art adopts a method of arranging a flux printer, a ball mounter mounted with a solder ball, and the like in a row and delivering a substrate among the apparatuses using a belt conveyor. As an electronic component manufacturing apparatus of the related art, JP-A-11-121473 (Patent Literature 1) discloses an electronic component manufacturing apparatus in which a belt conveyor that can linearly move is arranged, a substrate mounted on the belt conveyor is delivered to apparatuses, and the respective apparatuses perform processing. That is, Patent Literature 1 discloses an electronic component manufacturing apparatus that continuously performs, in an integrated line, a series of processing from mounting of a semiconductor chip on a substrate to sealing of the semiconductor chip or the like.

The electronic component manufacturing apparatus disclosed in Patent Literature 1 is configured to convey a circuit board using the belt conveyor and adopts a system for delivering the circuit board from the conveyor to the apparatuses using lifters provided in the apparatuses. In this system, while the circuit board moves on the belt conveyor, a force acts on the circuit board during the start and the stop of the operation of the belt conveyor and positional deviation of the circuit board occurs. In order to prevent the positional deviation of the circuit board, the apparatuses need to always perform operation for alignment of the circuit board before starting processing.

Further, the electronic component manufacturing apparatus disclosed in Patent Literature 1 is configured to lay one belt conveyor over all the apparatuses to convey the circuit board. If an apparatus having a long tact time is present, the belt conveyor is driven to match the apparatus. Therefore, it is difficult to reduce a tact time.

If the thickness of a substrate is as thin as 0.5 mm to 0.1 mm, a large bend occurs in the substrate and the substrate cannot be conveyed by the belt conveyor. If a belt for preventing a bend is provided in the substrate center, since the belt passes the table center, for example, accurate printing cannot be performed.

### SUMMARY OF THE INVENTION

Therefore, an object of the present invention is to solve the problems and provide a solder ball printing and mounting apparatus that can be reduced in size, convey a thin bent substrate with simple operation, and accurately print a necessary quantity of solder balls.

In order attain the object, the present invention provides a solder ball printing and mounting apparatus including: a first conveying unit including a first conveying carrier configured to be mounted with a substrate and convey the substrate to a flux printer; a first carry-in mechanism provided in an upper part on the flux printer side of the first conveying unit and provided above the first conveying carrier to be movable in a substrate conveying direction; a first carry-out mechanism for transferring the substrate, on which flux is printed by the flux printer, onto a second conveying carrier; a second carry-in mechanism for transferring the substrate from the second conveying carrier onto a solder ball printer; and a second carry-out mechanism for transferring the substrate loaded with a solder ball onto a third conveying carrier. A camera unit provided in the first carry-in mechanism and a camera unit provided in the first carry-out mechanism simultaneously pick up images of alignment marks provided at four corners of the substrate placed on a printing table of the flux printer and alignment marks provided at four corners of a mask. Camera units provided in the second carry-in mechanism and the second carry-out mechanism pick up images of the alignment marks provided in the substrate placed on a printing table of a solder ball printer and the mask. A control unit calculates a positional deviation amount to translate horizontally the printing tables and correct positional deviation.

By adopting the configuration explained above, it is possible to eliminate deformation of the substrate during substrate conveyance, smoothly deliver the substrate onto the printing tables, reduce time required for printing, and perform accurate solder ball printing.

### BRIEF DESCRIPTION OF THE DRAWINGS

FIG. 1 is a schematic configuration diagram of a solder ball printing and mounting apparatus;

FIG. 2 is a front view of a flux printer and peripheral equipment;

FIG. 3A is a top view of a first conveying unit;

FIG. 3B is a sectional view of the first conveying unit;

FIG. 4A is a sectional view of a first conveying carrier;

FIG. 4B is a sectional view of the first conveying carrier in a state in which substrate drop prevention plate arms operate when a substrate is transferred; and

FIGS. 5A to 5D are diagrams for explaining the operation of the solder ball printing and mounting apparatus.

### DETAILED DESCRIPTION

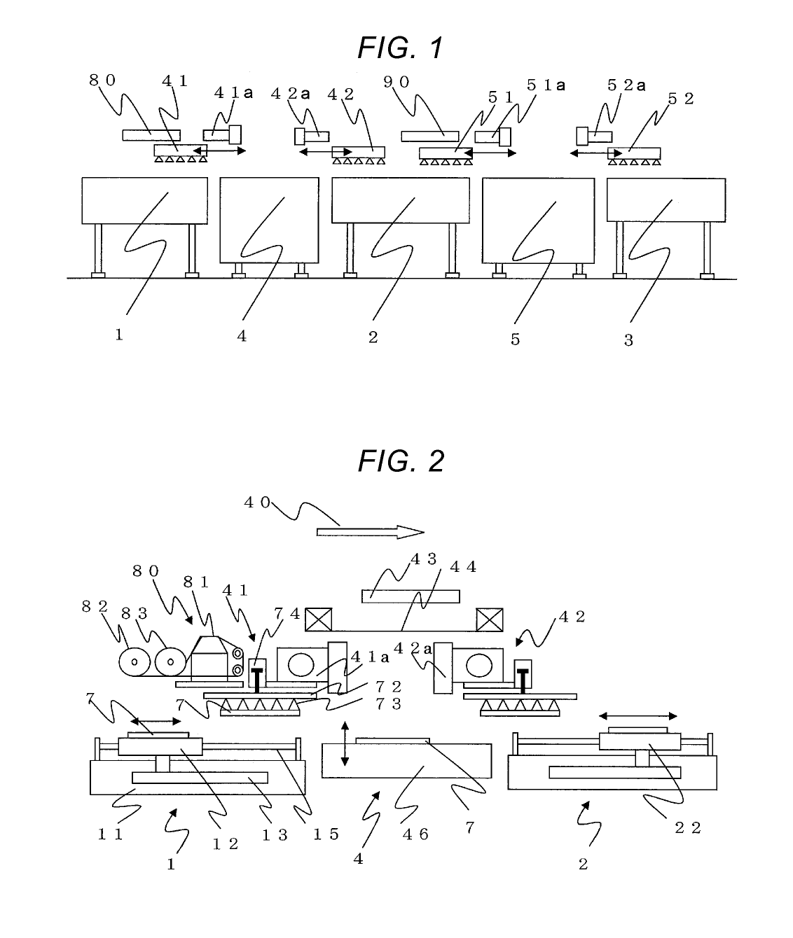

The present invention is explained below with reference to the drawings. An overall arrangement diagram of a solder ball printing and mounting apparatus according to the present invention is shown in FIG. 1. A schematic configuration of a flux printing unit is shown in FIG. 2.

As shown in FIG. 1, in the solder ball printing and mounting apparatus according to the present invention, a flux printer 4 and a solder ball printer 5 are linearly arranged. The solder ball printing and mounting apparatus includes a first conveying unit 1 configured to convey a substrate to be printed to the flux printer 4, a second conveying unit 2 configured to convey the substrate, on which flux is printed by the flux printer 4, to the solder ball printer 5, and a third conveying unit 3 configured to convey the substrate printed by the solder ball printer 5 to an inspection and repair device or a reflow oven not shown in the figure. For delivery of the substrate from the first conveying unit 1 to the flux printer 4, a first carry-in mechanism 41 including a plurality of attraction pads is provided to be capable of moving back and forth between an upper part of the first conveying unit 1 and the flux printer 4. A first stencil cleaner 80 is provided adjacent to the first carry-in mechanism 41. A first carry-out mechanism 42 for delivering the substrate to the second conveying unit 2 after receiving the substrate from the flux printer 4 and a second carry-in mechanism 51 for delivering the substrate from the second conveying unit 2 to the solder ball printer 5 are provided. Further, a second carry-out mechanism 52 for receiving the substrate from the solder ball printer 5 and delivering the substrate to the third conveying unit 3 is provided. A second stencil cleaner 90 is provided adjacent to the second carry-in mechanism 51. Further, camera units 41a, 42a, 51a, and 52a for detecting alignment marks are respectively provided on the printer sides of the first carry-in mechanism, the second carry-in mechanism, the first carry-out mechanism, and the second carry-out mechanism and configured to move together with the first and second carry-in mechanisms and the first and second carry-out mechanisms. Alignment marks are provided at four corners of the substrate to be printed. The camera units 41a, 42a, 51a, and 52a of the carry-in mechanisms and the carry-out mechanisms simultaneously detect the marks in the front and the back in a substrate conveying direction to perform alignment.

A state of substrate conveyance performed mainly by the flux printer is shown in FIG. 2.

A substrate 7 carried into the first conveying unit 1 moves in a white arrow 40 direction. The substrate 7 is transferred onto a printing table 46 of the flux printer 4 by the first carry-in mechanism 41. Images of alignment marks provided on the substrate 7 on the printing table 46 and a mask 44 are picked up by the camera unit 41a and the camera unit 42a. Flux is printed on the substrate 7 after alignment. When the printing ends, the substrate 7 is delivered to the second conveying unit 2 by the first carry-out mechanism 42. The first conveying unit 1 is configured such that a first conveying carrier 12 can be moved in the horizontal direction on a first conveying carrier stand 11 by a driving unit including a linear rail 15 and a rod-less pneumatic cylinder 13. The first carry-in mechanism 41 for delivering the substrate 7, which is placed on the first conveying carrier 12 and conveyed, onto the printing table 46 is provided. In the first carry-in mechanism 41, a plurality of attraction pads 73 including negative pressure supply holes are provided on an attraction pad supporting plate 72. A plurality of attraction holes are provided on a substrate placing surface of the first conveying carrier 12. Negative pressure is supplied to the attraction holes to hold the substrate 7 and prevent the substrate 7 from deviating during conveyance of the substrate 7.

In the first carry-in mechanism 41, as a driving device that can move the attraction pad supporting plate 72 up and down, an attraction-pad-up-down driving mechanism 74 configured by a cylinder is provided to be connected to an upper part of the attraction pad supporting plate 72. The camera unit 41a for detecting the positions of the alignment marks provided on the substrate in advance is attached to the first carry-in mechanism 41 and provided to be capable of moving in the horizontal direction together with the first carry-in mechanism 41. The first stencil cleaner 80 configured to clean a mask lower surface of the flux printer 4 is provided adjacent to the first carry-in mechanism 41. The first stencil cleaner 80 is configured to unwind cleaning cloth from an unwinding drum 83 and wind the cleaning cloth around a winding drum 82 through a cleaning unit 81. The first stencil cleaner 80 and the camera unit 41a are coupled by a not-shown cylinder. The first stencil cleaner 80 moves the cleaning unit 81 in a substrate conveying direction and cleans the mask 44 while bringing the cleaning unit 81 into contact with the lower surface of the mask 44. The printing table 46 is configured to be capable of moving up down and in the horizontal direction (an XYθ direction) while being mounted with the substrate 7. The mask 44 is provided above the printing table 46. After the alignment marks provided at the four corners of the substrate are detected by the camera unit 41a and the camera unit 42a and alignment is performed, the substrate 7 mounted on the printing table 46 can rise to a position where the substrate 7 on the printing table 46 comes into contact with a mask surface. That is, images of two points on the substrate conveying direction side (the front side) are picked up by the camera unit 42a and images of two points on the rear side are picked up by the camera unit 41a. A positioning stopper is provided such that the substrate 7 can be roughly positioned in the X and Y directions by the conveying unit 1 before the substrate 7 is placed on the printing table 46. When the substrate 7 is transferred onto the printing table 46, large positional deviation does not occur.

Distal ends of X-direction substrate positioning mechanisms 16 and Y-direction substrate positioning mechanisms 17 of the first carry-in mechanism 41 may be configured such that stoppers can be easily attached to and detached from the distal ends using a magnet or the like to make it possible to change the positions of the distal ends when a substrate size is changed.

A squeegee head 43 for printing flux, which is supplied onto the mask surface, on a substrate electrode via an opening section of the mask 44 is provided above the mask 44. Not-shown urethane rubber or the like is attached to a head attachment member to enable the squeegee head 43 to move up and down. Further, the head attachment member is provided with a head driving mechanism including a ball screw and a driving motor to perform (horizontal) reciprocating movement in a direction perpendicular to the substrate conveyance.

In FIG. 2, the substrate conveyance is explained using a state of substrate delivery of the flux printer. However, a peripheral configuration of the solder ball printer is substantially the same. However, since a printing target is different, the structure of the squeegee head 43 for printing flux and the structure of a loading head 45 for loading a solder ball are different. Explanation concerning detailed configurations of the squeegee head 43 and the solder ball loading head 45 is omitted.

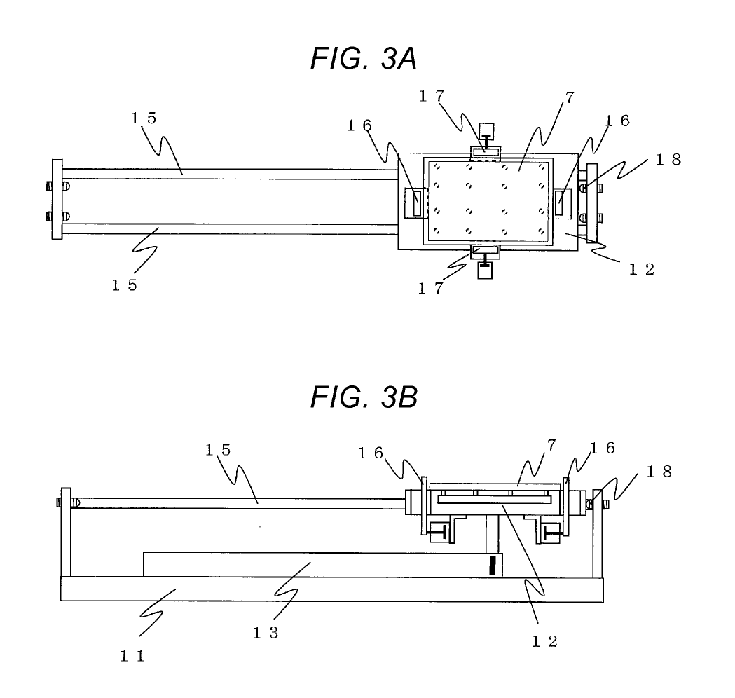

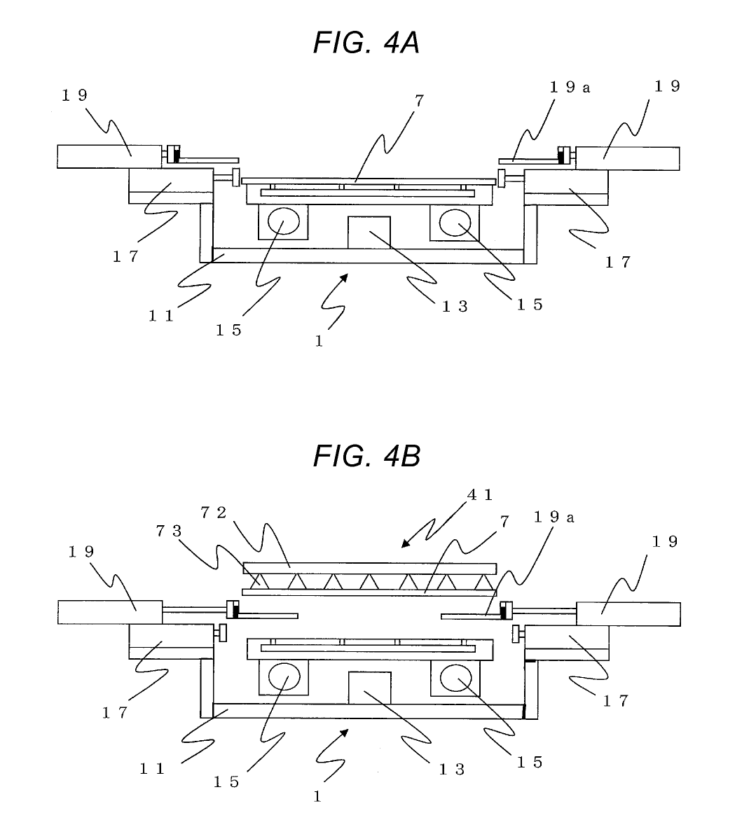

Schematic structure of the first conveying unit is shown in FIGS. 3A and 3B. A cross section in a Y direction is shown in FIGS. 4A and 4B. The substrate conveying direction of the first conveying carrier 12 is represented as X direction and a direction perpendicular to the substrate conveying direction is represented as Y direction.

The first conveying unit 1 includes the first conveying carrier stand 11, the first carrier unit 12 provided on the first conveying carrier stand 11 and mounted with the substrate 7, the rod-less pneumatic cylinder 13 for driving the first carrier unit 12, a pair of X-direction substrate positioning mechanisms 16 and a pair of Y-direction substrate positioning mechanisms 17 for substantially fixing a mounting position of a substrate when the substrate is delivered to the first carry-in mechanism 41. The second conveying unit 2 and the third conveying unit 3 are configured substantially the same as the first conveying unit 1. An adjustment bolt 18 is provided to adjust a stop position of the first conveying carrier 12. Similar stop position adjusting stoppers are provided in the second conveying unit 2 and the third conveying unit 3.

As shown in FIGS. 4A and 4B, a lower part of the substrate 7 is held by substrate drop prevention plate arms 19a including driving cylinders 19 to prevent the substrate 7 from being damaged if the substrate 7 drops when the first carry-in mechanism 41 attracts and holds the substrate 7.

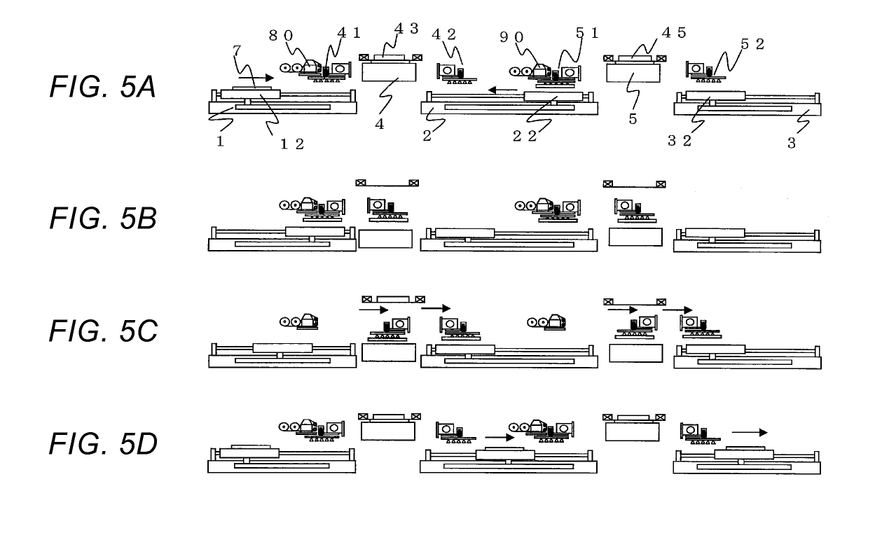

The operation of the apparatus is explained with reference to FIGS. 5A to 5D.

FIG. 5A shows states of the units of the solder ball printing and mounting apparatus that is performing printing of flux and printing (loading) of a solder ball in the flux printer 4 and the solder ball printer 5.

The first conveying carrier 12 of the first conveying unit 1 is mounted with the substrate 7 and moves in the direction of the flux printer 4. At this point, the first carry-in mechanism 41 stays on standby on the first conveying unit 1 side. The first carry-out mechanism 42 stays on standby on the second convening unit 2. A second conveying carrier 22 of the second conveying unit 2 moves to the flux printer 4 side and stays on standby under the first carry-out mechanism 42. The flux printer 4 is printing flux on the electrode of the substrate 7. The second carry-in mechanism 51 attracts and holds the substrate, which is received from the second substrate conveying carrier 22, rises, and stays on standby. At this point, as shown in FIG. 4B, the arms 19a are extended to prevent a drop of the substrate 7 such that the substrate 7 is not damaged even if the substrate 7 drops. The solder ball printer 5 loads a solder ball on the substrate electrode to which the flux is applied. The second carry-out mechanism 52 stays on standby on the third conveying unit 3 until the solder ball printer 5 completes the mounting of the solder ball.

When the printing of the flux and the loading of the solder ball are completed on the substrate, the solder ball printing and mounting apparatus shifts to a state of FIG. 5B. That is, the first conveying carrier 12 of the first conveying unit 1 is mounted with the substrate 7 and moves to the flux printer 4 side. The first carry-in mechanism 41 staying on standby in the upper part of the first conveying unit 1 attracts and holds the substrate 7 and stays on standby. The solder ball printing and mounting apparatus lowers the printing table of the flux printer 4 and starts the first carry-out mechanism 42 staying on standby on the second conveying unit 2. The solder ball printing and mounting apparatus attracts and holds the substrate 7, on which the flux is printed, on the table using the first carry-out mechanism 42. The second conveying carrier 22 of the second conveying unit 2 moves to the flux printer 4 side. The second carry-in mechanism 51 holding the substrate, on which the flux is printed, continues the standby state. The solder ball printer 5 that ends the loading of the solder ball descends. The second carry-out mechanism 52 moves onto a solder ball printing table and attracts and holds the substrate on which the loading is completed. A third conveying carrier 32 of the third conveying unit 3 maintains the standby state.

The solder ball printing and mounting apparatus shifts to a step in FIG. 5C. That is, when the substrate 7 printed by the flux printer 4 is attracted and held by the first carry-out mechanism 42 and moved to the second conveying unit 2 side, at the same time, the first carry-in mechanism 41 holding the substrate 7 on the first conveying unit 1 and staying on standby moves onto the printing table of the flux printer 4. The first carry-out mechanism 42 moves onto the second conveying carrier 22 of the second conveying unit 2 and delivers the substrate 7 onto the second conveying carrier 22. The second carry-in mechanism 51 moves onto the solder ball printer 5 and delivers the substrate 7, on which the flux is printed, onto the printing table. When the second carry-in mechanism 51 operates, at the same time, the second carry-out mechanism 52 operates, moves the substrate loaded with the solder ball onto the third conveying carrier 32 of the conveying unit 3, and delivers the substrate onto the carrier.

A step in FIG. 5D is explained.

In this step, the first conveying unit 1 mounts the new substrate 7 on the first conveying carrier 12. The first carry-in mechanism 41 in the upper part of the first conveying unit 1 stays on standby in an empty state. The flux printer 4 prints flux. In the second conveying unit 2, the second conveying carrier 22 is mounted with the substrate 7, on which the flux is printed, and is moving to the solder ball printer 5 side. The first carry-out mechanism 42 stays on standby on the second conveying unit 2 in an empty state. Similarly, the second carry-in mechanism 51 stays on standby on the second conveying unit 2 in order to receive the substrate 7 on which the flux is printed.

The solder ball printer 5 performs printing of a solder ball. The third conveying carrier 32 of the third conveying unit 3 is mounted with the substrate, on which the printing (the loading) of the solder ball ends, and moving to the substrate carry-out side. The second carry-out mechanism 52 stays on standby on the third conveying unit 3.

When the printing of the flux is performed several tens times, in a state in which the printing table is lowered, the solder ball printing and mounting apparatus moves the first carry-in mechanism 41 and the first stencil cleaner 80 in the substrate moving direction until the first stencil cleaner 80 is located on the lower surface of the mask 44. The solder ball printing and mounting apparatus lifts the mask 44 until the cleaning cloth of the cleaning unit 81 of the first stencil cleaner 80 comes into contact with the rear surface of the mask 44. Thereafter, the solder ball printing and mounting apparatus moves the first stencil cleaner 80 in the substrate conveying direction to execute stencil cleaning. When the stencil cleaning of the mask ends, a dirty part of the cleaning cloth is wound and the stencil cleaner 80 and the first carry-in mechanism 41 return to standby positions.

In delivering the substrate 7 from the conveying carrier to the printing table or from the printing table to the conveying carrier using the first and second carry-in mechanisms and the first and second carry-out mechanisms, for example, as shown in FIG. 2, the solder ball printing and mounting apparatus attracts and holds the substrate on the first conveying carrier and places the substrate on the flux printing table using the first carry-in mechanism 41. Thereafter, the solder ball printing and mounting apparatus moves the first carry-in mechanism 41 and the first carry-out mechanism 42 onto the substrate and picks up images of the alignment marks provided at the four corners of the substrate and the alignment marks provided on the mask using the camera units 41a and 42a. The solder ball printing and mounting apparatus calculates a positional deviation amount using a not-shown control unit. Cameras provided in the camera units are up-and-down two visual field cameras and can simultaneously pick up images of the substrate 7 and the mask 44. When the positional deviation amount is calculated, the solder ball printing and mounting apparatus moves the printing table 46 in the horizontal direction to perform alignment. When the alignment ends, the solder ball printing and mounting apparatus retracts the first carry-in mechanism 41 and the first carry-out mechanism 42 and lifts the printing table 46 and brings the printing table 46 into contact with a mask surface. Subsequently, the solder ball printing and mounting apparatus lowers a printing head to the mask surface, brings the squeegee into contact with the mask surface, and translates horizontally the printing head to perform printing of flux. When the printing of the flux ends, the solder ball printing and mounting apparatus lowers the flux printing table 46, moves the first carry-out mechanism 42 onto the printing table 46, attracts and holds the substrate 7, moves the substrate 7 to the second conveying unit 2, and places the substrate 7 on the second conveying carrier 22. The overview of the printing operation is as explained above.

In the solder ball printer 5, the alignment of the substrate and the mask is performed in operation substantially the same as the operation in the flux printer.

By adopting the configuration explained above, it is possible to convey even an easy-to-bend thin substrate, reduce time required for delivery of the substrate, and perform accurate printing.

What is claimed is:

1. A solder ball printing and mounting apparatus comprising:
a first conveying unit including a first conveying carrier configured to be mounted with a substrate and convey the substrate to a flux printer;
a first carry-in mechanism provided in an upper part on the flux printer side of the first conveying unit and provided above the first conveying carrier to be movable in a substrate conveying direction for transferring the substrate from the first conveying carrier to the flux printer;
a first carry-out mechanism for transferring the substrate, on which flux is printed by the flux printer, onto a second conveying carrier;
a second carry-in mechanism for transferring the substrate from the second conveying carrier onto a solder ball printer; and
a second carry-out mechanism for transferring the substrate loaded with a solder ball onto a third conveying carrier, wherein
a camera unit provided in the first carry-in mechanism and a camera unit provided in the first carry-out mechanism simultaneously pick up images of alignment marks provided at four corners of the substrate placed on a printing table of the flux printer and alignment marks provided at four corners of a mask arranged above the flux printer and above a solder ball printer,
camera units provided in the second carry-in mechanism and the second carry-out mechanism pick up images of the alignment marks provided in the substrate placed on a printing table of a solder ball printer and the mask, and
a control unit calculates a positional deviation amount to translate horizontally the printing tables and correct positional deviation.

2. The solder ball printing and mounting apparatus according to claim 1, wherein
a plurality of vacuum attraction pads are provided on attraction pad supporting plates in the first and second carry-in mechanisms and the first and second carry-out mechanisms, and
a driving mechanism for moving the vacuum attraction pad supporting plate up and down and a vacuum mechanism for supplying negative pressure to the attraction pads are connected to the first and second carry-in mechanisms and the first and second carry-out mechanisms.

3. The solder ball printing and mounting apparatus according to claim 1, wherein
a plurality of attraction holes are provided on substrate placing surfaces of the first to third conveying carriers and substrate placing surfaces of a printing table and a solder ball printing table for printing the flux and the solder ball, and
negative pressure is supplied to the attraction holes during substrate conveyance and during substrate printing to fix the substrate on the placing surfaces.

4. The solder ball printing and mounting apparatus according to claim 1, wherein positioning mechanisms in an X direction and a Y direction for defining a mounting position of the substrate are provided in the first to third conveying carriers provided in the first to third conveying units.
